(19) United States
(12) Patent Application Publication
(10) Pub. No.: US 2026/0288962 A1
(43) Pub. Date: Sep. 24, 2026

(54) DATA PROTECTION METHOD AND SYSTEM, STORAGE SERVER, AND CLIENT TERMINAL

(71) Applicant: CLOUD INTELLIGENCE ASSETS HOLDING (SINGAPORE) PRIVATE LIMITED, Singapore (SG)

(72) Inventor: Jun PIAO, Hangzhou, Zhejiang (CN)

(21) Appl. No.: 19/469,970

(22) PCT Filed: Apr. 2, 2024
(86) PCT No.: PCT/CN2024/085521

§ 371 Date: Sep. 26, 2025

(30) Foreign Application Priority Data
Apr. 4, 2023 (CN) 202310352365.X

(51) Int. Cl. G06F 21/56

(52) U.S. Cl. CPC G06F 21/568; G06F 2221/033

(57) ABSTRACT

The present disclosure relates to the field of cloud computing technologies, and discloses a data protection method and system, a storage server, and a client terminal. The data protection method includes: reading, in response to a received read/write request, data stored in a target order in a cloud disk; converting the data into a target file system format, and rearranging the data in the target file system format in the target order, where the target file system format is compatible with a file system of the client terminal; scanning the rearranged data in the target file system format to obtain a malicious software identification result; and processing the malicious software identification result to recover or protect the data stored in the cloud disk. achieves

The present disclosure is a National Stage of the International Application No. PCT/CN2024/085521, filed on Apr. 2, 2024, which claims priority to Chinese Patent Application No. 202310352365.X, filed with the China National Intellectual Property Administration on Apr. 4, 2023 and entitled “DATA PROTECTION METHOD AND SYSTEM, STORAGE SERVER, AND CLIENT TERMINAL”, and these applications are incorporated herein by reference in their entireties.

### TECHNICAL FIELD

The present disclosure relates to the field of cloud computing, and specifically, to a data protection method and system, a storage server, and a client terminal.

### BACKGROUND

This part is intended to provide a background or a context for embodiments of the present disclosure stated in the claims. The description herein is not admitted to be the prior art although included in this part.

With the development of cloud computing technologies, an increasing number of clients build Internet technology (IT) infrastructure based on a public cloud. Although mainstream public cloud manufacturers can significantly improve security of IT resources of public cloud manufacturers through technologies such as virtualization and network isolation at an infrastructure as a service (IaaS) layer, virtual machines of the clients are interconnected with an external public network and are easily attacked by viruses. To resolve this problem, in the prior art, elastic block storage (EBS) cloud disk data of the clients is protected from malicious software. The specific process is to regularly take a snapshot of the EBS cloud disk, then restore the snapshot to a new EBS cloud disk, and scan the new EBS cloud disk for viruses. Although this solution may play a certain role in providing post-incident protection against malicious software, malicious software cannot be scanned and supervised in real time. In addition, scanning needs to consume certain storage costs.

### SUMMARY

Embodiments of the present disclosure provide a data protection method and system, a storage server, and a client terminal, to identify malicious software more timely and reduce a data security risk.

According to an aspect of the present disclosure, a data protection method is further provided. The method includes: reading, in response to a received read/write request, data stored in a target order in a cloud disk; converting the data into a target file system format, and rearranging the data in the target file system format in the target order, where the target file system format is compatible with a file system of the client terminal; scanning the rearranged data in the target file system format to obtain a malicious software identification result; and processing the malicious software identification result to recover or protect the data stored in the cloud disk.

According to another aspect of the present disclosure, a storage server is further provided, including a protection module and an elastic block storage (EBS) module, where the protection module is configured to perform the foregoing steps of the method.

According to another aspect of the present disclosure, a client terminal is further provided, including an application module, a file system, and a block device, where the application module is configured to send a read/write request to the foregoing storage server through the file system and the block device, so that the EBS module stores data in a target order based on the read/write request.

According to another aspect of the present disclosure, a data protection system is further provided, including a client terminal and a storage server. The storage server includes a protection module and an EBS module. The protection module is configured to perform the foregoing steps of the method. The client terminal includes an application module, a file system, and a block device. The application module is configured to send a read/write request to the storage server through the file system and the block device, so that the EBS module stores data in a target order based on the read/write request.

According to another aspect of the present disclosure, an electronic device is further provided, including a processor and a memory storing a program, where the program includes an instruction, the instruction, when executed by the processor, causing the processor to perform the foregoing method.

According to another aspect of the present disclosure, a non-transitory computer-readable storage medium storing a computer instruction is further provided, where the computer instruction is used to cause a computer to perform the steps of the foregoing method.

According to another aspect of the present disclosure, a computer program product is further provided. The computer program product includes a computer program, and the computer program, when executed by a processor, implements the steps of the foregoing method.

In the embodiments of the present disclosure, data stored in a target order in a cloud disk is read in response to a received read/write request, the data is converted into a target file system format, and the data in the target file system format is rearranged in the target order, where the target file system format is compatible with a file system of the client terminal. The rearranged data in the target file system format is scanned to obtain a malicious software identification result, and the malicious software identification result is processed to recover or protect the data stored in the cloud disk. In the present disclosure, data stored in a target order in a cloud disk is read in response to a read/write request, the data is converted into a target file system format that is compatible with a file system of a client terminal, and then rearranged data in a target file system format is continuously tracked and scanned, thereby achieving real-time performance of malicious software identification, reducing a data security risk to the maximum extent, and reducing a storage cost because there is no need to plan a separate storage space for a scanning task.

### BRIEF DESCRIPTION OF THE DRAWINGS

More details, features, and advantages of the present disclosure are disclosed in the following description of exemplary embodiments with reference to the accompanying drawings. In the accompanying drawings:

FIG. 1 shows a flowchart of a data protection method according to an embodiment of the present disclosure;

FIG. 2 shows an architecture diagram of an existing cloud disk data protection solution;

FIG. 3 shows an architecture diagram of a data protection method according to an embodiment of the present disclosure;

FIG. 4 shows a structural block diagram of an exemplary electronic device that can be configured to implement an embodiment of the present disclosure; and

FIG. 5 shows a schematic structural diagram of a storage server according to an embodiment of the present disclosure.

### DESCRIPTION OF EMBODIMENTS

Embodiments of the present disclosure are to be described in more detail below with reference to the accompanying drawings. Although some embodiments of the present disclosure are shown in the accompanying drawings, it should be understood that the present disclosure may be implemented in various forms, and should not be construed as being limited to the embodiments described herein. On the contrary, these embodiments are provided to provide a more thorough and complete understanding of the present disclosure. It should be understood that the accompanying drawings and the embodiments of the present disclosure are for illustrative purposes only, and are not intended to limit the protection scope of the present disclosure.

It should be understood that various steps described in the method implementations of the present disclosure may be performed in different orders and/or performed in parallel. In addition, the method implementations may include additional steps and/or omit performing of shown steps. The scope of the present disclosure is not limited in this aspect.

A term “include” and its variants as used herein are open-ended inclusions, meaning “including but not limited to”. The term “based on” means “at least partially based on”. The term “an embodiment” means “at least one embodiment”. The term “another embodiment” means “at least one additional embodiment”. The term “some embodiments” means “at least some embodiments”. Related definitions of other terms are to be provided in the following description. It should be noted that concepts such as “first” and “second” mentioned in the present disclosure are only used to distinguish different apparatuses, modules, or units, and are not used to limit an order or a relation of interdependence of functions performed by the apparatuses, modules, or units.

It should be noted that the modifier “one” or “a plurality of” mentioned in the present disclosure is illustrative rather than restrictive. A person skilled in the art should understand that unless otherwise explicitly indicated in the context, the modifier should be understood as “one or more”.

It should be noted that user information (including but not limited to user equipment information, user personal information, and the like) and data (including but not limited to data for analysis, stored data, displayed data, and the like) involved in the present disclosure are all authorized by the user or information and data fully authorized by all parties. The collection, use, and processing of relevant data need to conform to relevant laws, regulations, and standards of relevant countries and regions, and corresponding operation portals are provided for the user to choose to authorize or refuse.

Names of messages or information exchanged between a plurality of apparatuses in the implementations of the present disclosure are merely used for illustrative purposes, and are not used to limit the scope of the messages or information.

With the widespread application of computer technologies and high popularity of Internet technologies, malicious software has also become prevalent. Since such malicious software is highly contagious, hidden, and destructive, the malicious software has become a major problem plaguing the computer industry and even the Internet industry.

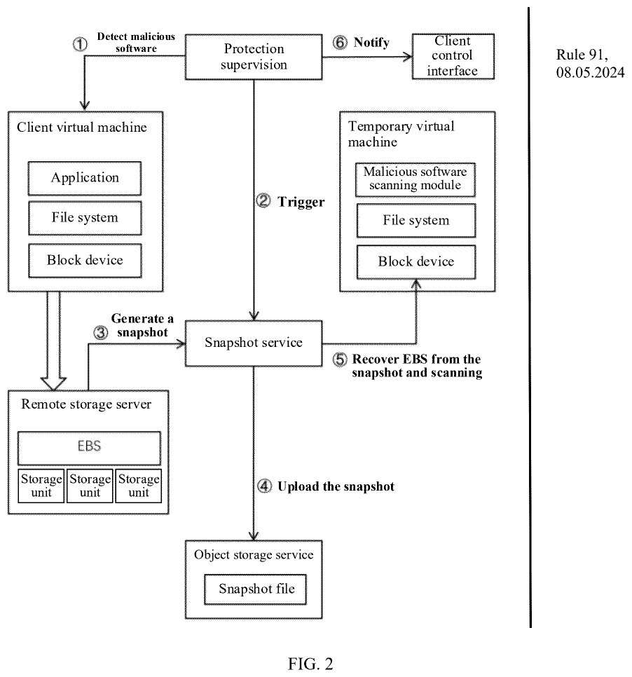

Referring to an architectural diagram of an existing cloud disk data protection solution shown in FIG. 2, the architecture of the existing solution includes:
1. A client virtual machine, which provides computing resources, storage resources, network resources, and the like for an application program of a client;
a. Application: it is an application program of a client;
b. File system: it is a file system in an operating system of the client that provides a data storage service for an upper-layer application, and is configured to save key data of the client;
c. Block device: it is a virtual block device presented and stored in a client virtual machine by an elastic block storage (EBS) block, and provides a block interface for an upper-layer file system;
2. A remote storage server serves as a physical storage resource of the EBS block device;
a. EBS: it serves as a remote server of the EBS block device, and provides a block device resource access capability for a client terminal on a computing side;
b. Storage unit: it is a physical storage unit forming the EBS, configured to dispersedly store client data in different magnetic disks to improve data performance and reliability;
3. A snapshot service, which provides capabilities of making a snapshot based on the EBS block device and restoring from the snapshot;
4. An object storage service, which is used to save a snapshot file; and
5. A temporary virtual machine, which is configured to provide a running environment for scanning software;
a. A malicious software scanning module, which is configured to perform security scanning on EBS data of a client through open source or commercial anti-virus software.

Based on the foregoing architecture, the following steps are performed based on the process of serial numbers \textcircled{1} to \textcircled{6} in FIG. 2.

A protection supervision module supervises an abnormal behavior of a client EC2 in real time, for example, interacting through a command with a suspicious external service, or being attacked maliciously. After a suspicious event occurs, the protection supervision module notifies a snapshot service module to make a snapshot for the EBS of the client. Then the snapshot service module makes a snapshot for the EBS and saves a snapshot file in a remote object storage service module. The protection supervision module starts a temporary virtual machine of the EC2, restores a new EBS through the snapshot service module, loads the new EBS into the EC2, and performs malicious software scanning on data of the EBS through the malicious software scanning module. Once malicious software is found, the malicious software scanning module reports the malicious software to the client for next processing through the protection supervision module.

In a scanning process of the solution, a snapshot and new EBS storage need to be created, and additional storage resources and additional computing resource overheads are introduced. The computing resource is for example a temporary virtual machine. Introduction of additional resources may increase scanning costs, and snapshot creation is periodic, resulting in an excessively large recovery point objective (RPO), and causing loss of a large amount of valid data during data recovery. Recovery of a snapshot is at a level of the entire cloud disk, which may result in loss of a large amount of valid data.

An intrusion process of malicious software is very covert and difficult to prevent through interception in advance. In addition, malicious software such as ransomware may cause great damage to client data, and it is often too late when the problem is discovered. Although the snapshot is currently used as a means of backup and recovery, it cannot be ensured that valid data is included in the snapshot. In addition, the snapshot is based on a recovery granularity of an entire magnetic disk, easily causing large-range loss of valid data.

Based on the foregoing background, the present disclosure provides a data protection method and system, a storage server, and a client terminal. In the method, security scanning may be performed based on data of an EBS stored in a target order, and a separate storage space does not need to be planned for a scanning task, thereby reducing a storage cost. Through the method, client data can be further recovered and restored based on a continuous data protection (CDP) technology, to reduce an RPO and reduce loss of valid data. In addition, the method further implements a data recovery capability of a file granularity, thereby further reducing the loss of valid data.

Terms involved in the present disclosure are described below.
Recovery point objective (RPO): it refers to a data recovery point objective, mainly referring to an amount of data loss that a service system can tolerate.
Recovery time objective (RTO): it refers to a recovery time objective, mainly referring to a maximum tolerable service outage time, that is, a minimum time period from occurrence of a disaster to the recovery of service functions of the service system.
Log-structured: it is a data storage manner, in which metadata and data are appended to a circular log file in sequence.

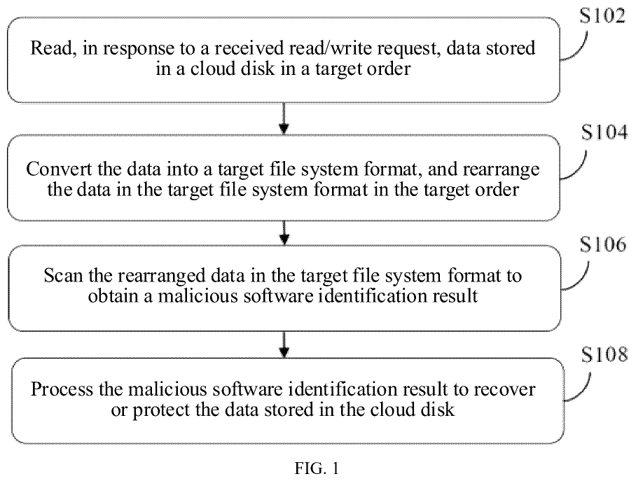

This embodiment provides a data protection method. FIG. 1 is a flowchart of a data protection method according to an embodiment of the present disclosure. Steps of the method involved in FIG. 1 are described below.
Step S102: read, in response to a received read/write request, data stored in a cloud disk in a target order.

In the step, the read/write request may be sent by a client terminal, the client terminal may be a client virtual machine, and a client sends the read/write request to an EBS through a file system and a block device in an application of the client virtual machine. The read/write request may be used to store the data in the cloud disk in the target order. For example, the data may be stored in the EBS of the cloud disk in chronological order based on the read/write request, thereby ensuring that data at a historical moment and real-time data are both stored persistently.

After the EBS completes data storage once based on the read/write request, in the present disclosure, the data stored in the cloud disk is read in real time in accordance with the target order in which data is stored in the EBS. The target order may be used to specify, based on an actual requirement, an order in which data is stored in the cloud disk. Compared with storage in a manner such as a random order, a problem of data inaccuracy caused by mutual interference of data during subsequent data processing may be prevented. A specific order adopted for the target order is not specifically limited in the embodiments of the present disclosure. For example, the order may be chronological order, an order of data importance, or an order of labeling. If the order is chronological order, the cloud disk may specifically store data in a log-structured manner.

It should be noted that when data is stored based on a log-structured structure, data is continuously added to the log-structured data structure in all write operations, and an existing value is not updated. Therefore, the data stored in the cloud disk in the log-structured manner may be read continuously and in real time based on such a characteristic of the log-structured structure.

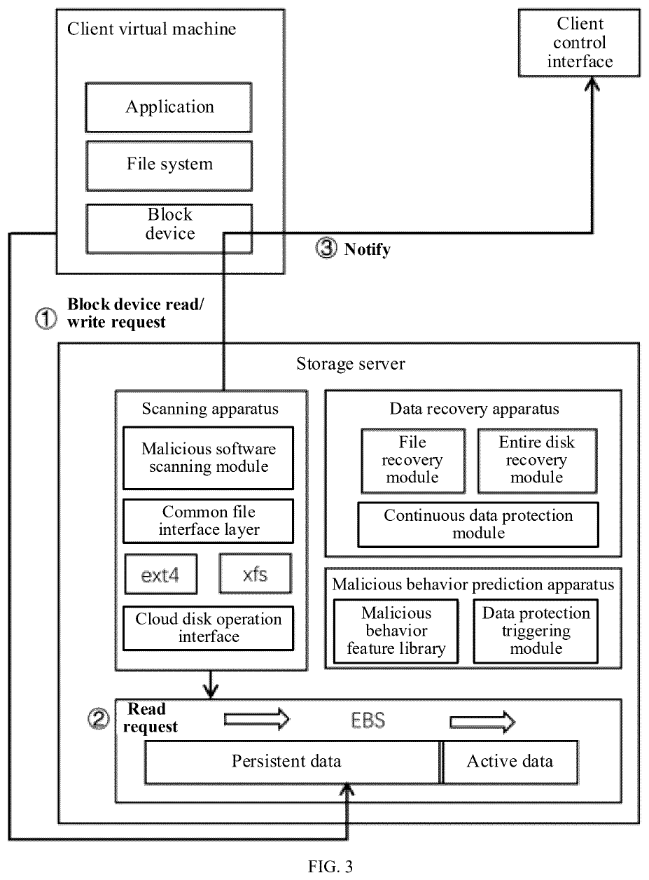

In addition, it should be noted that referring to the architecture diagram of the data protection method shown in FIG. 3, the EBS may include persistent data that has completed write operations and active data that is being written. Data stored in the cloud disk in a log-structured manner is read. During specific implementation, the persistent data in the EBS may be read through a cloud disk operation interface.
Step S104: convert the data into a target file system format, and rearrange the data in the target file system format in the target order, where the target file system format is compatible with a file system of the client terminal.

In the step, various files in a client operating system may be interfaced through a unified file system abstraction layer. Various types of file systems are, for example, a fourth extended file system (ext4), and a high-performance log file system (xfs). During specific implementation, a target file system format is determined based on a file system format in a client operating system, so that the target file system format is compatible with a file system of the client terminal, and data read from an EBS is converted into the target file system format.

It should be noted that during rearrangement of the data in the target file system format, the rearrangement also needs to be performed in the foregoing target order, to ensure that an arrangement order of the target file system format after the rearrangement is consistent with a reading order in which the data stored in the cloud disk is read, to reduce a probability of an error during the subsequent data processing.

In the step, the target file system format may be some common file system formats, for example, may be ext4, xfs, and a new technology file system (NTFS, a file system of a Windows NT environment). Therefore, in a possible implementation, the converting the data into the target file system format may be implemented based on the following step: converting the data into an ext4 file, an xfs file, or an NTFS file. Then the data in the target file system format is rearranged in a target order in which the data in the EBS is read.

It should be noted that since a storage order of the data converted into the target file system format may change, through a rearrangement operation, the storage order of the data in the target file system format is consistent with an order in which data stored in the cloud disk is read, so as to facilitate subsequent identification of malicious software.
Step S106: scan the rearranged data in the target file system format to obtain a malicious software identification result.

In the step, the rearranged data in the target file system format is continuously tracked and scanned. Since different malicious software exhibit different behavioral features, for example, deleting a large amount of data, reading a large amount of data, destroying a large amount of data, and modifying a large amount of data, it is identified, based on the operation behavior on the data in the data in the target file system format, whether malicious software exists, to obtain a malicious software identification result.

It should be noted that malicious software is a general definition, and may be divided into two categories based on the nature of damage caused by the malicious software. The first category mainly includes a backdoor program, a keylogger, a password stealer, spyware, and the like, which reside in a client computer and endanger client's benefits by stealing important data such as an online banking password and a private photo. The second category is a new type of computer virus called “ransomware”, and mainly spreads in a manner such as an email or a Trojan program. Such a virus irreversibly encrypts a file through various encryption algorithms. The infected parties are usually unable to decrypt the files, and needs to obtain a private key from a virus distributor for decryption. The virus distributor extorts high ransom using important data of the client. In the step, either of the foregoing two categories of malicious software may be identified by scanning the rearranged data in the target file system format. In addition to the categories of malicious software listed above, other malicious software having a specific behavioral feature may further be identified.

In the foregoing step, an intrusion behavior of malicious software may be discovered in real time. In addition, in the step, scanning may be directly completed in a production area where data is stored, and a separate storage space does not need to be planned for a scanning task, thereby reducing a storage cost.

It should be noted that information in a malicious software library may be continuously updated, and an update strategy may be determined based on an actual requirement. This is not specifically limited herein in the embodiments of the present disclosure.
Step S108: process the malicious software identification result to recover or protect the data stored in the cloud disk.

In the step, the malicious software identification result may be used to determine corrupted data, and operations such as deletion and recovery may be performed on the corrupted data, to recover or protect data stored in the cloud disk, thereby reducing a security risk of the data, and ensuring security of the data. A specific processing means adopted may be determined based on an actual requirement. This is not specifically limited in the embodiments of the present disclosure.

In the embodiments of the present disclosure, data stored in a target order in a cloud disk is read in response to a received read/write request, the data is converted into a target file system format, and the data in the target file system format is rearranged in the target order, where the target file system format is compatible with a file system of the client terminal. The rearranged data in the target file system format is scanned to obtain a malicious software identification result, and the malicious software identification result is processed to recover or protect the data stored in the cloud disk. In the present disclosure, data stored in a target order in a cloud disk is read in response to a read/write request, the data is converted into a target file system format that is compatible with a file system of a client terminal, and then rearranged data in a target file system format is continuously tracked and scanned, thereby achieving real-time performance of malicious software identification, reducing a data security risk to the maximum extent, and reducing a storage cost because there is no need to plan a separate storage space for a scanning task.

In a possible implementation, the scanning the rearranged data in the target file system format to obtain a malicious software identification result may be performed based on the following steps: scanning the rearranged data in the target file system format to obtain scanning information; identifying, by using a malicious software library, target malicious software in the scanning information and a target file damaged by the target malicious software, where the malicious software library is configured to provide behavioral feature information of the target malicious software; and using the target malicious software and/or the target file as the malicious software identification result.

In the possible implementation, the rearranged data in the target file system format is scanned to obtain scanning information. A malicious software library may be generated in advance. The malicious software library is configured to provide a file and behavioral feature information of the target malicious software as a basis for determining the malicious software and the infected file in the foregoing scanning information. In other words, target malicious software in the scanning information and a target file damaged by the target malicious software are identified by using the malicious software library, and the target malicious software and/or the target file is taken as the malicious software identification result.

After the malicious software is identified, to prevent the malicious software from further increasing damage or damaging an increasing amount of data, in a possible implementation, the processing the malicious software identification result may be performed based on the following steps: generating a processing instruction based on the malicious software identification result, and sending the processing instruction to a control terminal, where the processing instruction is used to delete and/or isolate the malicious software identification result.

In the embodiments of the present disclosure, the identified malicious software or the file damaged by malicious software may be located based on the malicious software identification result, a processing instruction is generated, and the instruction is sent to the control terminal, so that the control terminal deletes and/or isolates the identified malicious software or the file damaged by malicious software based on the processing instruction. It should be noted that the control terminal may be a part of a user terminal and is controlled through the user terminal, or may be an independent control terminal and may be set based on an actual requirement. This is not specifically limited herein in the embodiments of the present disclosure.

If a file damaged by malicious software is found, and the file includes important data, to reduce the loss of valid data and provide a larger RPO, in a possible implementation, the processing the malicious software identification result may be performed based on the following steps: determining a recovery moment of an intruded file, and recovering the intruded file based on the recovery moment or deleting the intruded file.

In the embodiments of the present disclosure, the recovery moment of the intruded file may be determined in combination with a CDP technology and according to an actual requirement. A specific recovery time point depends on a different strategy. For example, a moment when the file was just created, a period of time before a moment when malicious software intrudes, or any moment defined by a client may be the recovery moment, or the file may be directly cleared, and then the intruded file is recovered based on the recovery moment or the intruded file is deleted.

It should be noted that the CDP provides a new data protection means for a user, and a system manager does not need to pay attention to a data backup process (because a CDP system constantly monitors changes of key data, thereby implementing data protection constantly and automatically). In addition, data can be quickly restored simply by selecting a desired time point to restore only after a disaster occurs.

In the CDP technology, all file access operations are captured in real time by implanting a file filtering driver in a core layer of an operating system. For a file that needs continuous backup protection by the CDP, when intercepting a rewrite operation thereof through a file filtering driver, a CDP management module automatically backs up a changed part of the file data together with a current system time stamp to a CDP storage repository in advance. Theoretically, any change to file data is automatically recorded, and therefore is referred to as continuous data protection.

In the foregoing steps, more accurate protection of valid data can be achieved, thereby implementing a data recovery capability of a file granularity and further reducing loss of valid data.

If no important data needs to be protected after the malicious software intrudes, in a possible implementation, the processing the malicious software identification result may be performed based on the following step: recovering a target storage area of the cloud disk to a state that has not been intruded by malicious software if any file in the malicious software identification result does not meet a preservation condition.

In the embodiments of the present disclosure, the preservation condition may be set based on an actual requirement, to screen out a file that needs to be saved. The target storage area may be an entire magnetic disk of the cloud disk. After the malicious software intrudes, if no important data exists in the cloud disk, that is, any file in the malicious software identification result does not meet the preservation condition, the target storage area of the cloud disk is restored to a state that has not been intruded by the malicious software, for example, restored to a period of time before a moment of the intrusion of the malicious software.

It should be noted that when any file in the malicious software identification result does not meet the preservation condition, a magnetic disk-granularity repair function may be enabled, and the entire magnetic disk may be directly restored to a non-intruded state. If any file in the malicious software identification result meets the preservation condition, a recovery operation may be performed based on the foregoing file-granularity repair function.

Considering that malicious software may have a large number of behaviors with certain features such as large-scale deletion, reading or destruction, to intercept a potential intrusion behavior, the method may further include the following steps:
determining a risk behavior based on the data stored in the target order through a machine learning model and a malicious behavioral feature library; generating an interception instruction, and sending the interception instruction to a control terminal, so that the control terminal intercepts the risk behavior.

In the embodiments of the present disclosure, the malicious behavioral feature library is configured to provide feature information of a risk behavior, and a machine learning model may be trained in advance by using the malicious behavioral feature library. An abnormal behavior in the data stored in the target order is identified in real time by using the trained machine learning model. In other words, a risk behavior is determined based on the data stored in the target order by using the machine learning model and the malicious behavioral feature library. If an abnormality is found, an interception operation on a potential intrusion behavior is triggered. In other words, an interception instruction is generated, and the interception instruction is sent to a control terminal, so that the control terminal intercepts the risk behavior.

It should be noted that the control terminal may be a part of a user terminal and is controlled through the user terminal, or may be an independent control terminal and may be set based on an actual requirement. This is not specifically limited herein in the embodiments of the present disclosure.

The present disclosure further provides a storage server. Referring to a schematic structural diagram of a storage server shown in FIG. 5, the storage server 500 includes a protection module 501 and an EBS module 502. The protection module is configured to perform the steps of any of the foregoing data protection methods. Specific implementations of the data protection methods are not described herein again.

Referring to an architecture diagram of a data protection method shown in FIG. 3, a possible architecture of a storage server and an operating process of the architecture are described below.

The foregoing protection module in the storage server may include the following architecture:
a. Malicious software scanning module: it is responsible for performing malicious software scanning on client cloud disk data, and precisely identifying malicious software and a file destroyed by the malicious software;
i. a malicious software library provides files and behavioral features of malicious software, and serves as a basis for determining malicious software and an infected file;
ii. a file system adaptation apparatus (a general file interface layer in FIG. 3) is configured to provide a unified file system abstraction layer to interface with various file systems in a client operating system; and
iii. a cloud disk operation interface is configured to access cloud disk data;
b. Data recovery apparatus: after user data is intruded by malicious software, it is responsible for recovering data to a state before the intrusion or clearing a damaged file;
i. a file recovery module is used for file-granularity repair function, and may precisely clear a malicious file and an infected file or directly restore the infected file to an uninfected state;
ii. an entire disk recovery module is used for magnetic disk-granularity repair function, and may directly recover an entire magnetic disk to the non-intruded state; and
iii. a continuous data protection module is configured to provide a continuous protection capability of data and provide a data recovery function at any moment;
c. Malicious behavior prediction apparatus: it is configured to perform prediction on a data destruction behavior of malicious software based on a malicious software feature library and a machine learning algorithm;
i. malicious behavioral feature library: it is responsible for tracking an operation behavior of client data and predicting a possible malicious software destruction behavior; and
ii. data protection triggering module: it is responsible for instructing a scanner to intercept a potential intrusion behavior after a potential data destruction risk is found.

The foregoing EBS module in the storage server may include the following architecture:
a. persistent data: it refers to historical data of a client cloud disk recorded based on a log-structured data structure; and
b. active data: it is latest data written to the client cloud disk.

Based on the architecture shown in FIG. 3, the foregoing data protection method may be implemented through the following steps based on the process of \textcircled{1}-\textcircled{3} in FIG. 3:
1. An application of a virtual machine of the client sends a block device read/write request to the EBS through a file system and a block device layer.
2. The EBS stores data in a log-structured manner, to ensure that data at a historical moment and real-time data are both stored persistently.
3. A scanning apparatus reads persistent data through a cloud disk operation interface in chronological order.
4. The scanning apparatus converts the log-structured data format of the EBS into a common file system format such as ext4 or xfs through a common file interface layer, and rearranges the client data in chronological order.
5. The scanning apparatus performs security scanning on the rearranged data through the malicious software scanning module, finds an intrusion behavior of malicious software in real time, and notifies the data recovery apparatus to recover or isolate the data:
a. if malicious software is found, a client is notified to delete or isolate the malicious software;
b. if a file destroyed by malicious software is found, the file is recovered through the file recovery module, and a specific recovery time point depends on a different strategy, for example, 1) the file is restored to a moment when the file was just created, 2) the file is restored to a period of time before a moment when malicious software intrudes, 3) the file is directly cleared, or the like, 4) or any moment defined by the client; and
c. if no important data needs to be protected after the malicious software intrudes, the entire magnetic disk may be recovered through the entire disk recovery module, for example, recovered to a period of time before a moment when the malicious software intrudes.
6. In addition, the malicious behavior prediction apparatus detects an abnormal behavior in real time based on a data feature of the client, and if an abnormal behavior is found, the scanning apparatus is triggered to intercept a potential intrusion behavior.

During the implementation of the data protection method through the storage server, log-structured data is continuously tracked and scanned, thereby achieving real-time performance of identification of malicious software, and reducing the data security risk to the maximum extent. In addition, the scanning is directly completed in a production area of data storage, and a separate storage space does not need to be planned for a scanning task, thereby reducing a storage cost, providing lower RPO (Recovery Point Objective) and RTO (Recovery Time Objective) capabilities, and reducing the loss of valid data to the maximum extent after data is intruded by the malicious software. The present disclosure significantly reduces storage costs, resolves a problem that a scanning task intrudes a client environment, and may further identify malicious software more timely and protect valid data more accurately. The present disclosure implements intelligent malicious software protection based on the characteristic of a log-structured storage structure of public cloud block storage, and may be applied to an EBS storage product related to cloud computing and a cloud security related product.

The present disclosure further provides a client terminal, including an application module, a file system, and a block device. The application module is configured to send a read/write request to the foregoing storage server through the file system and the block device, so that the EBS module stores data in a target order based on the read/write request.

It should be noted that the client terminal may be a client virtual machine, providing computing resources, storage resources, network resources, and the like for an application program of a client. The file system may be a file system in an operating system of the client that provides a data storage service for an upper-layer application, and is configured to save key data of the client. The block device may be a virtual block device presented and stored in a client virtual machine by an EBS block, and provides a block interface for an upper-layer file system. The storage server may serve as a physical storage resource of the EBS block device.

The present disclosure further provides a data protection system, including a client terminal and a storage server. The storage server includes a protection module and an EBS module. The protection module is configured to perform the foregoing steps of the method. The client terminal includes an application module, a file system, and a block device. The application module is configured to send a read/write request to the storage server through the file system and the block device, so that the EBS module stores data in a target order based on the read/write request.

The present disclosure further provides a data protection apparatus. The apparatus includes: an interface module, configured to read, in response to a received read/write request, data stored in a cloud disk in a target order;
a file conversion module, configured to convert the data into a target file system format, and rearrange the data in the target file system format in the target order, where the target file system format is compatible with a file system of the client terminal; a malicious file scanning module, configured to scan the rearranged data in the target file system format to obtain a malicious software identification result; and a data recovery module, configured to process the malicious software identification result to recover or protect the data stored in the cloud disk.

The system or apparatus is configured to implement functions of the methods in the foregoing embodiments. Each module in the system or apparatus corresponds to each step in the method. For those that are already described in the methods, details are not described herein again.

In an embodiment, the converting the data into a target file system format includes: converting the data into an ext4 file, an xfs file, or an NTFS file.

In an embodiment, the scanning the rearranged data in the target file system format to obtain a malicious software identification result includes: scanning the rearranged data in the target file system format to obtain scanning information; identifying, by using a malicious software library, target malicious software in the scanning information and a target file damaged by the target malicious software, where the malicious software library is configured to provide behavioral feature information of the target malicious software; and taking the target malicious software and/or the target file as the malicious software identification result.

In an embodiment, the processing the malicious software identification result includes: generating a processing instruction based on the malicious software identification result, and sending the processing instruction to a control terminal, where the processing instruction is used to delete and/or isolate the malicious software identification result.

In an embodiment, the processing the malicious software identification result includes: determining a recovery moment of an intruded file, and recovering or deleting the intruded file based on the recovery moment.

In an embodiment, the processing the malicious software identification result includes: recovering a target storage area of the cloud disk to a state that has not been intruded by malicious software if any file in the malicious software identification result does not meet a preservation condition.

In an embodiment, it further includes: determining a risk behavior based on the data stored in the target order by using a machine learning model and a malicious behavioral feature library; and generating an interception instruction, and sending the interception instruction to a control terminal, so that the control terminal intercepts the risk behavior.

An exemplary embodiment of the present disclosure further provides an electronic device, including at least one processor and a memory communicatively connected to the at least one processor. The memory stores a computer program that can be executed by the at least one processor, and the computer program, when executed by the at least one processor, is configured to cause the electronic device to perform the method according to the embodiments of the present disclosure.

An exemplary embodiment of the present disclosure further provides a non-transitory computer-readable storage medium storing a computer program, where the computer program, when executed by a processor of a computer, is configured to cause the computer to perform the method according to the embodiments of the present disclosure.

An exemplary embodiment of the present disclosure further provides a computer program product, including a computer program. The computer program, when executed by a processor of a computer, is configured to cause the computer to perform the method according to the embodiments of the present disclosure.

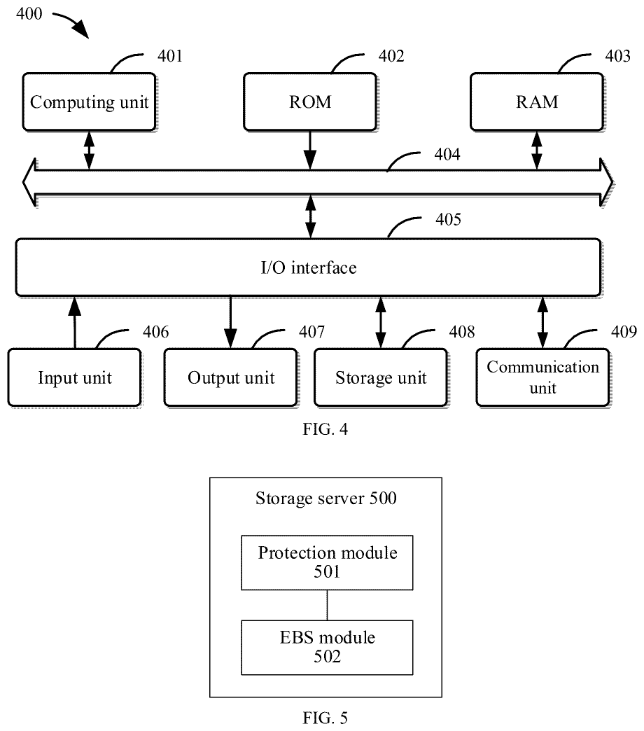

Referring to FIG. 4, a structural block diagram of an electronic device 400 that may be used as a server or a client of the present disclosure is described, which is an example of a hardware device that may be applied to various aspects of the present disclosure. The electronic device is intended to represent various forms of digital electronic computer devices, such as a laptop computer, a desktop computer, a workbench, a personal digital assistant, a server, a blade server, a mainframe computer, and another suitable computer. The electronic device may further represent various forms of mobile apparatuses, such as a personal digital assistant, a cellular phone, a smart phone, a wearable device, and another similar computing apparatus. The components shown herein, their connections and relationships, and their functions are merely used as examples, and are not intended to limit implementation of the present disclosure described and/or required herein.

As shown in FIG. 4, the electronic device 400 includes a computing unit 401, which may perform various appropriate actions and processing based on a computer program stored in a read-only memory (ROM) 402 or a computer program loaded into a random access memory (RAM) 403 from a storage unit 408. The RAM 403 may further store various programs and data required for operations of the device 400. The computing unit 401, the ROM 402, and the RAM 403 are connected to each other through a bus 404. An input/output (I/O) interface 405 is also connected to the bus 404.

A plurality of components in the electronic device 400 are connected to the I/O interface 405, including an input unit 406, an output unit 407, a storage unit 408, and a communication unit 409. The input unit 406 may be any type of device that can input information to the electronic device 400. The input unit 406 may receive input digital or character information, and generate a key signal input related to a user setting and/or function control of the electronic device. The output unit 407 may be any type of device that can present information, and may include, but is not limited to, a display, a speaker, a video/audio output terminal, a vibrator, and/or a printer. The storage unit 408 may include, but is not limited to, a magnetic disk and an optical disc. The communication unit 409 allows the electronic device 400 to exchange information/data with another device through a computer network such as the Internet and/or various telecommunication networks, and may include, but is not limited to, a modem, a network card, an infrared communication device, a wireless communication transceiver, and/or a chipset, for example, a Bluetooth device, a Wi-Fi device, a WiMAX device, a cellular communication device, and/or the like.

The computing unit 401 may be various general-purpose and/or dedicated processing components having processing and computing capabilities. Some examples of the computing unit 401 include, but are not limited to, a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and the like. The computing unit 401 performs the various methods and processes described above. For example, in some embodiments, the foregoing data protection method may be implemented as a computer software program that is tangibly included in a machine-readable medium such as the storage unit 408. In some embodiments, a part or all of the computer program may be loaded into and/or installed on the electronic device 400 through the ROM 402 and/or the communication unit 409. In some embodiments, the computing unit 401 may be configured to perform the foregoing data protection method in any other appropriate manner (for example, through firmware).

Program code for implementing the method of the present disclosure may be written in any combination of one or more programming languages. These program codes may be provided to a processor or a controller of a general-purpose computer, a dedicated computer, or another programmable data processing apparatus, so that the program code, when executed by the processor or the controller, causes functions/operations specified in the flowchart and/or the block diagram to be implemented. The program code may be fully executed on a machine, partially executed on a machine, partially executed on a machine and partially executed on a remote machine as an independent software package, or fully executed on a remote machine or a server.

In the context of the present disclosure, the machine-readable medium may be a tangible medium, which may include or store a program used by an instruction execution system, an apparatus, or a device or used in combination with the instruction execution system, the apparatus, or the device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing content. More specific examples of the machine-readable storage medium include an electrical connection based on one or more wires, a portable computer disk, a hard disk, a random access memory (RAM), a read-only memory (ROM), an erasable programmable ROM (EPROM or a flash memory), an optical fiber, a portable compact disc ROM (CD-ROM), an optical storage device, a magnetic storage device, or any suitable combination of the foregoing content.

As used in the present disclosure, the terms “machine-readable medium” and “computer-readable medium” refer to any computer program product, device, and/or apparatus (for example, a magnetic disk, an optical disc, a memory, or a programmable logic device (PLD)) configured to provide a machine instruction and/or data to a programmable processor, including a machine-readable medium that receives a machine instruction as a machine-readable signal. The term “machine-readable signal” refers to any signal used to provide a machine instruction and/or data to a programmable processor.

To provide interaction with a user, the system and technology described herein may be implemented on a computer. The computer has a display apparatus (for example, a cathode ray tube (CRT) or a liquid crystal display (LCD)) configured to display information to the user, a keyboard, and a pointing apparatus (for example, a mouse or a trackball). The user may provide input to the computer by using the keyboard and the pointing apparatus. Another type of apparatus may be further configured to provide interaction with a user. For example, feedback provided to the user may be any form of sensory feedback (for example, visual feedback, auditory feedback, or tactile feedback). In addition, input from the user may be received in any form (including acoustic input, voice input, or tactile input).

The system and technology described herein may be implemented in a computing system (for example, as a data server) including a background component, or a computing system (for example, an application server) including a middleware component, or a computing system (for example, a user computer having a graphical user interface or a network browser. A user may interact with implementations of the system and technology described herein through the graphical user interface or the network browser) including a frontend component, or a computing system including any combination of such a background component, middleware component, or frontend component. The components of the system may be connected to each other through digital data communication (for example, a communication network) in any form or medium. Examples of the communication network include a local area network (LAN), a wide area network (WAN), and the Internet.

The computer system may include a client terminal and a server. The client terminal and the server are generally far away from each other and usually interact with each other through a communication network. A relationship between the client terminal and the server is generated through computer programs that run on a corresponding computer and that have a client-server relationship with each other.

The foregoing descriptions are merely embodiments of the present disclosure, and are not intended to limit the present disclosure. For a person skilled in the art, the present disclosure may have various modifications and changes. Any modification, equivalent replacement, and improvement made within the spirit and principle of the present disclosure shall fall within the scope of claims of the present disclosure.

1. A data protection method, comprising:
reading, in response to a received read/write request, data stored in a cloud disk in a target order;
converting the data into a target file system format, and rearranging the data in the target file system format in the target order, wherein the target file system format is compatible with a file system of a client terminal;
scanning the rearranged data in the target file system format to obtain a malicious software identification result; and
processing the malicious software identification result to recover or protect the data stored in the cloud disk.

2. The method according to claim 1, wherein the converting the data into a target file system format comprises:
converting the data into a fourth extended file system (ext4) file, a high-performance log file system (xfs) file, or a new technology file system (NTFS) file.

3. The method according to claim 1, wherein the scanning the rearranged data in the target file system format to obtain a malicious software identification result comprises:
scanning the rearranged data in the target file system format to obtain scanning information;
identifying, by using a malicious software library, target malicious software in the scanning information and a target file damaged by the target malicious software, wherein the malicious software library is configured to provide behavioral feature information of the target malicious software; and
taking the target malicious software and/or the target file as the malicious software identification result.

4. The method according to claim 1, wherein the processing the malicious software identification result comprises:
generating a processing instruction based on the malicious software identification result, and sending the processing instruction to a control terminal, wherein the processing instruction is used to delete and/or isolate the malicious software identification result.

5. The method according to claim 1, wherein the processing the malicious software identification result comprises:
determining a recovery moment of an intruded file, and recovering or deleting the intruded file based on the recovery moment.

6. The method according to claim 1, wherein the processing the malicious software identification result comprises:
recovering a target storage area of the cloud disk to a state that has not been intruded by malicious software if any file in the malicious software identification result does not meet a preservation condition.

7. The method according to claim 1, further comprising:
determining a risk behavior based on the data stored in the target order by using a machine learning model and a malicious behavioral feature library; and
generating an interception instruction, and sending the interception instruction to a control terminal, so that the control terminal intercepts the risk behavior.

8. A storage server, comprising a protection circuit and an elastic block storage (EBS) circuit, wherein the protection circuit is configured to perform the following steps:
read, in response to a received read/write request, data stored in a cloud disk in a target order;
convert the data into a target file system format, and rearranging the data in the target file system format in the target order, wherein the target file system format is compatible with a file system of a client terminal;
scan the rearranged data in the target file system format to obtain a malicious software identification result; and
process the malicious software identification result to recover or protect the data stored in the cloud disk.

9. A client terminal, comprising an application circuit, a file system, and a block device, wherein
the application circuit is configured to send a read/write request to the storage server according to claim 8 through the file system and the block device, so that the EBS circuit stores data in a target order based on the read/write request.

10. A data protection system, comprising a client terminal and a storage server, wherein
the storage server comprises a protection circuit and an EBS circuit, the protection circuit is configured to perform the steps of the method according to claim 1; and
the client terminal comprises an application circuit, a file system, and a block device, and the application circuit is configured to send a read/write request to the storage server through the file system and the block device, so that the EBS circuit stores data in a target order based on the read/write request.

11. An electronic device, comprising:
a processor; and
a memory storing a program,
wherein the program comprises an instruction, the instruction, when executed by the processor, causing the processor to perform the steps:
read, in response to a received read/write request, data stored in a cloud disk in a target order;
convert the data into a target file system format, and rearranging the data in the target file system format in the target order, wherein the target file system format is compatible with a file system of a client terminal;
scan the rearranged data in the target file system format to obtain a malicious software identification result; and
process the malicious software identification result to recover or protect the data stored in the cloud disk.

12. A non-transitory computer-readable storage medium storing a computer instruction, wherein the computer instruction is used to cause a computer to perform the steps of the method according to claim 1.

13. (canceled)

14. The method according to claim 2, further comprising:
determining a risk behavior based on the data stored in the target order by using a machine learning model and a malicious behavioral feature library; and
generating an interception instruction, and sending the interception instruction to a control terminal, so that the control terminal intercepts the risk behavior.

15. The method according to claim 3, further comprising:
determining a risk behavior based on the data stored in the target order by using a machine learning model and a malicious behavioral feature library; and
generating an interception instruction, and sending the interception instruction to a control terminal, so that the control terminal intercepts the risk behavior.

16. The method according to claim 4, further comprising:
determining a risk behavior based on the data stored in the target order by using a machine learning model and a malicious behavioral feature library; and
generating an interception instruction, and sending the interception instruction to the control terminal, so that the control terminal intercepts the risk behavior.

17. The method according to claim 5, further comprising:
determining a risk behavior based on the data stored in the target order by using a machine learning model and a malicious behavioral feature library; and
generating an interception instruction, and sending the interception instruction to a control terminal, so that the control terminal intercepts the risk behavior.

18. The storage server according to claim 8, wherein the protection circuit is configured to:
convert the data into a fourth extended file system (ext4) file, an xfs file, or a new technology file system (NTFS) file.

19. The storage server according to claim 8, wherein the protection circuit is configured to:
scan the rearranged data in the target file system format to obtain scanning information;
identify, by using a malicious software library, target malicious software in the scanning information and a target file damaged by the target malicious software, wherein the malicious software library is configured to provide behavioral feature information of the target malicious software; and
take the target malicious software and/or the target file as the malicious software identification result.

20. The storage server according to claim 8, wherein the protection circuit is configured to:
generate a processing instruction based on the malicious software identification result, and send the processing instruction to a control terminal, wherein the processing instruction is used to delete and/or isolate the malicious software identification result.

21. The storage server according to claim 8, wherein the protection circuit is configured to:
determine a recovery moment of an intruded file, and recovering or deleting the intruded file based on the recovery moment.
